(19) United States
(12) Patent Application Publication
(10) Pub. No.: US 2022/0082172 A1
(43) Pub. Date: Mar. 17, 2022

(54) VALVE APPARATUS FOR CONTROLLING THE FLOW OF FLUIDS IN TWO TEMPERATURE CONTROL CIRCUITS, COMPENSATING TANK APPARATUS WITH SUCH A VALVE APPARATUS, AND A TEMPERATURE CONTROL CIRCUIT APPARATUS WITH SUCH A COMPENSATING TANK APPARATUS

(71) Applicant: ILLINOIS TOOL WORKS INC., Glenview, IL (US)

(72) Inventors: Kai GÜTTINGER, Darmstadt (DE); Peter QUADE, Walstrode (DE); Rolf HABERMANN, Bergen (DE)

(21) Appl. No.: 17/471,335

(22) Filed: Sep. 10, 2021

(30) Foreign Application Priority Data
Sep. 14, 2020 (DE) 10 2020 123 912.2

(51) Int. Cl. F16K 11/16; F16K 31/04

(52) U.S. Cl. CPC F16K 11/165; F01P 7/14; F16K 31/043

(57) ABSTRACT

A valve apparatus is provided for controlling the flow of fluids in two temperature control circuits and includes an actuator, a valve housing with a first receiving chamber and a second receiving chamber, a direct ball valve having the first receiving chamber with at least a first and a second fluid port, wherein a first ball device with a first passageway is rotatably mounted in the first receiving chamber, wherein the first ball device is coupled to the actuator and is directly actuatable by the actuator, and an indirect ball valve having the second receiving chamber with at least a third and a fourth fluid port, wherein in the second receiving chamber a second ball device with a second passageway is rotatably mounted, wherein the second ball device is coupled to the first ball device and is thus actuatable by the direct ball valve and indirectly actuatable by the actuator.

### TECHNICAL FIELD

The present invention relates to a valve apparatus for controlling the flow of fluids in two temperature control circuits, compensating tank apparatus with such a valve apparatus, and a temperature control circuit apparatus with such a compensating tank apparatus.

### BACKGROUND

A valve is a component for blocking or controlling the flow of fluids (liquids or gases)

In valves, a closure part (e.g. plate, cone, ball, or needle) is usually moved approximately parallel to the direction of flow or about an axis of rotation transverse to the direction of flow of the fluid. The flow is interrupted in that the closure part is pressed with the sealing surface to a suitably shaped opening, the valve or sealing seat.

In addition to blocking material flows, valves are well-suited for control tasks.

A compensating tank is a fitting that is used in small and large systems, in particular in motor vehicles having internal combustion engines. It is needed in order to compensate for its loss due to temperature-related expansion, evaporation, or vaporization of a liquid or gaseous operating means; in the case of temperature expansion, the fluctuating volume is compensated. Usually, the system pressure is maintained by means of the compensating tank and the provided operating means.

Actors, also known as actuators, are usually referred to as drive-technical components, which, for example, convert an electrical signal (commands issued by a control computer) into mechanical movements or changes in physical quantities such as pressure or temperature and thereby actively intervene in the controlled process.

### SUMMARY

The problem addressed by the present invention is to provide a compact and simply constructed valve apparatus for controlling the flow of fluids in two temperature control circuits.

A further problem addressed by the present invention is to provide a compact and simply constructed compensating tank apparatus.

In addition, a problem addressed by the present invention is to provide a temperature control circuit apparatus, with which two temperature control circuits are variably controllable.

One or more of these problems are achieved by the features of independent claims 1, 6, and 9. Advantageous configurations are specified in the respective dependent subclaims.

According to the present invention, a valve apparatus is provided for controlling the flow of fluids in two temperature control circuits. This apparatus comprises an actuator, a valve housing with a first receiving chamber and a second receiving chamber, a direct ball valve having the first receiving chamber with at least a first and a second fluid port, wherein a first ball device with a first passageway is rotatably mounted in the first receiving chamber, wherein the first ball device is coupled to the actuator and is directly actuatable by the actuator, and an indirect ball valve having the second receiving chamber with at least a third and a fourth fluid port, wherein in the second receiving chamber a second ball device with a second passageway is rotatably mounted, wherein the second ball device is coupled to the first ball device and is thus actuatable by the direct ball valve and indirectly actuatable by the actuator.

The expressions “direct” and “indirect” ball valve only describe the relation between the two valves. For example, a machine element, such as a gear box, with which movement variables (force or torque) can be changed can also be arranged between the direct ball valve or the first ball device and the actuator. The same applies to the coupling between the first and the second ball device.

Due to the fact that the first ball device of the direct or the directly controlled ball valve is coupled to the actuator and can be directly actuated by the actuator, and the second ball device of the second ball valve is coupled to the first ball device, the latter is pulled and/or towed along by the first ball device and is thus also indirectly driven or indirectly controlled via the actuator. In this way, only a single actuator is necessary in order to actuate the direct and indirect ball valves. Both ball valves of the valve apparatus are arranged in a common valve housing.

With the structure according to the invention, a compact and inexpensive valve apparatus is thus provided, as only one actuator is necessary for actuating both valves, and both valves are arranged in a single valve housing.

The ball valves are preferably spool valves, in which the blocking body is configured as a ball. In the spool variant, the ball has the corresponding passageway.

The first and second ball device can preferably be connected to each other via a positive-locking connection. In order to form the positive-locking connection, a first and second coupling element, respectively, can preferably be integrally formed on the first ball device and the second ball device. The first ball device and the second ball device are coupled together via the first and the second coupling elements. The coupling elements can be configured in the manner of a jaw coupling, wherein the corresponding jaws allow a predetermined degree of freedom of rotation, such that the second ball device is towable by the first ball device with an angular and/or time offset.

A temperature control circuit in the context of the present invention is understood to be a low-temperature or high-temperature and/or a heating and/or cooling circuit.

A bearing device for guiding and supporting the first and/or the second ball device in the valve housing can be arranged in a coupling region between the first ball device and the second ball device. The bearing device is preferably configured as a semi-solid bearing, such that a degree of freedom of rotation of the second ball device is restricted by an O-ring seat.

By means of the semi-solid bearing, the degree of rotational freedom is restricted in a ball rotation direction by the corresponding O-ring seat. In this case, a complete restriction of the degree of freedom of rotation does not take place, but rather only a protection against unintentional loosening of the free, pulled and/or towed second ball device. In addition, the fact that the free rotatability in the ball direction about a rotation axis of the second ball device is restricted by the semi-fixed bearing also prevents the need to perform a permanent position query of the ball position of the second ball device.

The ball valves can be configured as 3/2-way valves and/or as proportional valves.

A directional control valve is configured in order to partially or completely block the path of a working medium. A 3/2-way valve has three ports and two switch positions.

The number of fluid ports or outlets of the direct and the indirect ball valve are only limited by the available design space and the desired function. In theory, however, three or more outputs could also be provided on each ball. Thus, a different number and different combinations of ports and switch positions can also be realized.

A proportional valve in the context of the present invention is understood to be a valve for changing a flow rate. Proportional valves have a comparatively analogous switching behavior, in which intermediate positions between the two extremes “open” and “closed” are also possible. The flow rate can thus be regulated and controlled as needed. The ball valves can thus be proportional valves equipped as directional control valves having more than two working ports.

Due to the formation of the ball valves as 3/2-way valves and/or as proportional valves, a completely flexible control of the flow of fluids in two temperature control circuits is thus possible.

The second ball device can have an end stop for limiting the rotational movement. Furthermore, the second ball device can have an extended end stop, which allows a rotational movement of approximately 660 degrees to 700 degrees.

Without the provision of such an extended end stop, it can be that a maximum freedom of movement in the ball rotation direction between the end stops of 360 degrees is not achieved, and thus is not sufficient in order to drive two temperature control circuits completely flexibly. This is in particular because the formation of the two end stops is mostly at the expense of the angle of rotation due to their predetermined thickness. A high mobility of the indirectly controlled ball can be necessary in order to realize complex switch positions independently of the directly controlled ball.

Thus, according to the present invention, an end stop extension can be provided, which is a component part of the end stop(s). This contributes to further rotatability in the ball direction before reaching the end stop.

The actuator can be an electric motor, preferably an inductively working electric motor. Other designs, or for example the use of a thermally actuated expansion wax element, are contemplated. For example, an expansion wax element also converts thermal potential differences into mechanical movements. In the context of the present invention, an actuator can also comprise a mechanical actuation. The actuator is thus not necessarily limited to an electrical actuation.

In addition, according to the present invention, a compensating tank apparatus comprising a valve apparatus according to the present invention is provided. This is characterized in that the valve apparatus is an integral part of the compensating tank apparatus, and a valve housing of the valve apparatus is integrally connected to a housing of the compensating tank apparatus.

In that the valve apparatus is an integral part of the compensating tank apparatus, considerable design space can be saved, and a very compact design results. In addition, such a compensating tank apparatus can be manufactured more cost-effectively.

The integral connection between the valve apparatus and the compensating tank apparatus can be produced by an injection molding process in a single component or a multi-component injection molding process, by a latching connection, a screw connection, an adhesive connection, or a weld connection, or another suitable manufacturing process.

The compensating tank apparatus can comprise a first and second compensating tank, both of which can be fillable via a filling nozzle and/or can have a bypass line and/or can each have at least one fluid port, respectively.

Such a compensating tank apparatus without the valve apparatus according to the invention is disclosed in the as yet unpublished European Patent Application EP 20174528.8, which is hereby referred to in full.

In addition, according to the present invention, a temperature control circuit apparatus is provided. This circuit comprises a compensating tank apparatus as described above and a first temperature control circuit, wherein the first temperature control circuit is connected to a first and a second fluid port of a direct ball valve of a valve apparatus. In addition, the temperature control circuit apparatus comprises a second temperature control circuit connected to a third and a fourth fluid port of an indirect ball valve of the valve apparatus.

The first temperature control circuit can be configured as a high-temperature control circuit and/or a small circuit having a predetermined total volume, wherein the second temperature control circuit is configured as a low-temperature control circuit and/or a large circuit having a predetermined total volume, wherein its total volume is greater than the total volume of the first temperature control circuit. An inverted arrangement is also possible.

### BRIEF DESCRIPTION OF THE DRAWINGS

The present invention will be described in more detail in the following on the basis of an exemplary embodiment shown in the figures. The figures show:

FIG. 1 is a lateral view of a compensating tank apparatus according to the invention with a valve apparatus,

FIG. 2 is a further lateral view of the compensating tank apparatus with the valve apparatus,

FIG. 3 is a lateral sectional view along the line A-A from FIG. 2,

FIG. 4 is a perspective exploded view of the valve apparatus, and

FIG. 5 is a further exploded perspective view of the valve apparatus.

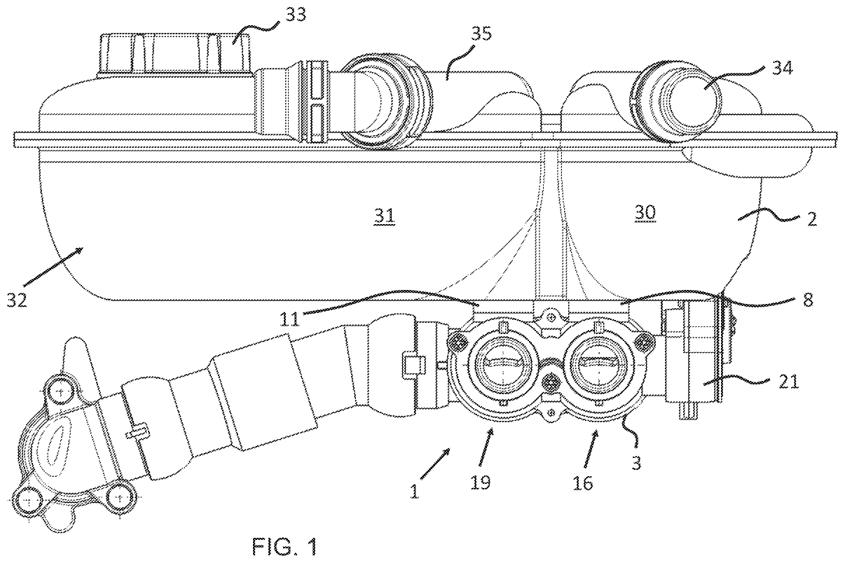

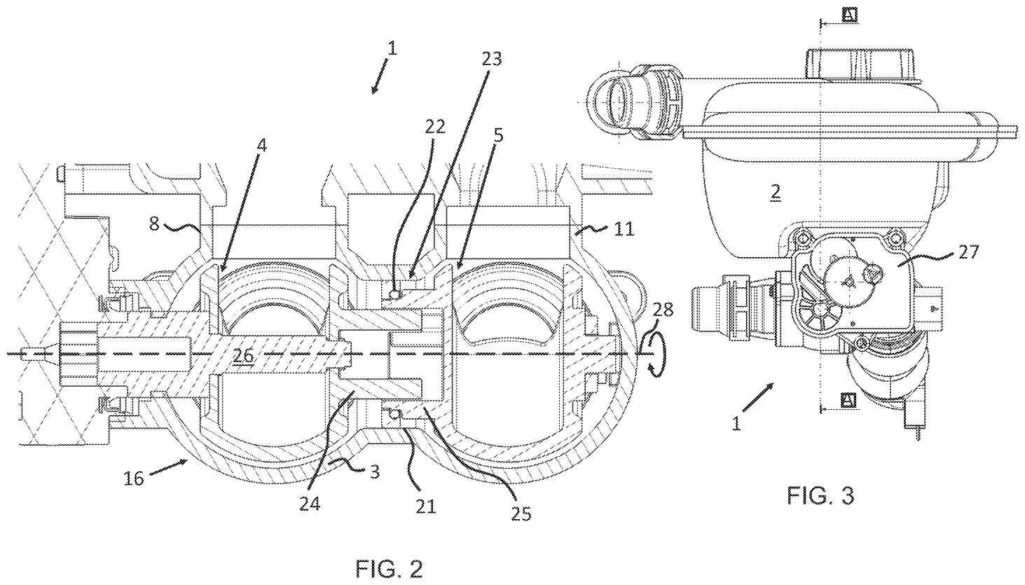

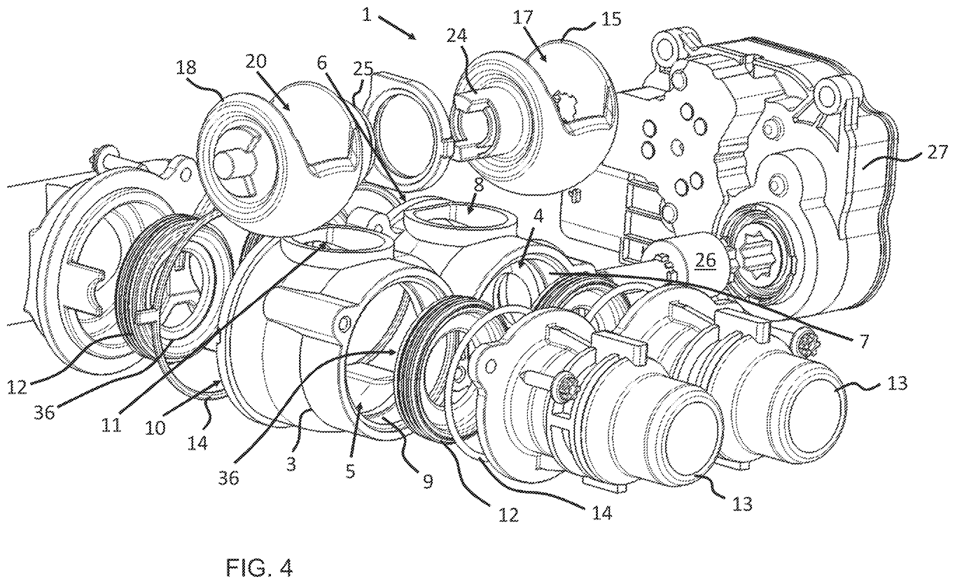

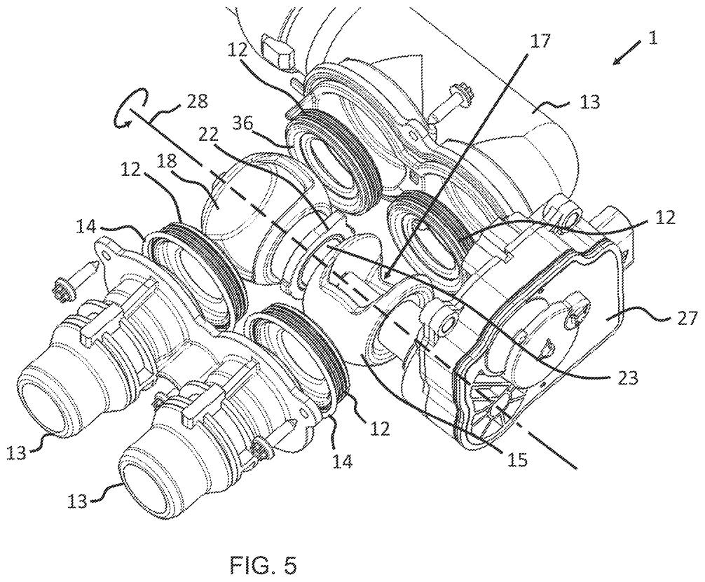

A valve apparatus 1 according to the invention for a compensating tank apparatus 2 is described in more detail in the following (FIGS. 1 to 5).

### DETAILED DESCRIPTION

The valve apparatus 1 is configured in order to control the flow of fluids in two temperature control circuits. The temperature control circuits can be corresponding heating and/or cooling circuits.

The valve apparatus 1 comprises a valve housing 3 with a first receiving chamber 4 and a second receiving chamber 5.

The first receiving chamber 4 has a first and a second fluid port 6, 7, which are preferably arranged diametrically opposite to one another. Furthermore, a first connection port 8 for connecting to the compensating tank apparatus 2 is provided on the first receiving chamber 4.

The second receiving chamber 5 has a third and a fourth fluid port 9, 10, which are preferably arranged diametrically opposite to one another. In addition, a second connection port 11 for connecting to the compensating tank apparatus 2 is provided on the first receiving chamber 5.

The positioning of the ports in relation to one another is only subject to the function and the available design space and can also be arranged differently than diametrically opposite, and three or more ports can also be provided.

Internal threads are formed in the fluid ports 6, 7, 9, and 10, into which centering/guiding inserts 12 equipped with a corresponding external thread, can be screwed. As an alternative to the internal threads, self-tapping screws can also be provided.

On a surface facing in the direction of a first and a second ball device 15, 18, which are described in more detail below, a circular segment-shaped sealing or guiding wall 36 is provided on each centering/guiding insert 12. The sealing wall 36 or the sealing element seals the fluid ports 6, 7, 9, and 10 or, respectively, the outlets and the ball devices 15, 18 to each other (in the closed state). The sealing wall 36 can be embodied as a 2K sealing element, for example. The guiding or sealing wall 36 can also be configured in order to center and guide the first and second ball device 15, 18 in the valve housing.

Connector sockets 13 are provided for connecting to corresponding temperature control circuits, via which sockets the fluid ports 6, 7, 9, and 10 can be connected to the corresponding temperature control circuits. The connector sockets 13 have a corresponding flange that is sealingly connectable to the valve housing 3 via an O-ring seal 14. A molding seal or other suitable seal can also be provided in place of the O-ring.

The first ball device 15 is arranged in the first receiving chamber 4. The first ball device 15 forms a blocking body for a direct ball valve 16, which additionally comprises the first receiving chamber 4. The first ball device 15 has a first passageway 17.

The second ball device 18 is arranged in the second receiving chamber 5 of the valve housing 3. The second ball device 18 forms an indirect ball valve 19 in connection with the second receiving chamber 5. The second ball device 18 has a second passageway 20.

In the valve housing 3, a bearing seat 21 for receiving a bearing device 22 is provided in the area between the first receiving chamber 4 and the second receiving chamber 5.

The bearing device 22 is configured in order to guide and support the first and the second ball device 15, 18. The bearing device 22 is preferably a semi-solid bearing, wherein a degree of rotational freedom of the second ball device 18 is partially restricted by an O-ring seat.

A through-opening 23 is formed in the bearing device.

A first and a second coupling element 24, 25 are each preferably integrally formed on the first ball device 15 and the second ball device 18. The first ball mechanism 15 and the second ball device 18 are coupled to one another via the first and the second coupling elements 24, 25. The coupling elements 24, 25 are configured in the manner of a jaw coupling, wherein the corresponding jaws allow for a predetermined free movement in the direction of rotation, such that the second ball device is towable by the first ball device 15 with an angular and/or time offset.

Starting from an end position corresponding to an end stop in either of the two possible rotational directions of an actuator 27 described in more detail below, the coupling elements of both balls are in direct operative contact in the direction of rotation in which the end stop is extended. A direct operative contact in the other direction of rotation is generally not given in this position. The coupling elements of the two balls do not have any direct operative contact in the opposite direction of rotation in this position. Thus, the non-directly driven ball is initially not moved in the opposite direction when the directly driven ball is moved. The shape and size of the coupling elements on both balls provides the maximum possible free movement of the driven ball before in turn establishing an operative contact in the opposite direction of rotation with the indirectly driven ball. This free movement is used in order to position the directly driven ball independently of the non-driven ball and to achieve the desired position and thus opening of the outlets.

Typically, the free mobility of the non-driven ball is arranged such that any combination of the positions of the balls with respect to the opening and closing of the different outlets to each other is possible. In order to control the indirectly driven ball, the free movement must be overcome by a rotation in the corresponding direction by the directly driven ball. Depending on the desired switching state of the directly driven ball, it must be rotated back, i.e. rotated in the opposite direction, after the positioning of the indirectly driven ball.

The first coupling element 24 and the second coupling element 25 are arranged in the through-opening 23 of the bearing device 22.

The first ball device 15 is connected to the actuator 27 via a control shaft 26. The actuator 27 is, for example, an electric motor, preferably an inductively working electric motor.

By means of the control shaft 26 or the actuator 27, the first ball device 15 of the direct ball valve 16 is directly driven and is movable into a rotational movement about a rotation axis 28.

The second ball device 18 of the indirect ball valve 19 also rotates about the axis of rotation 28 and is dragged along via the first and the second coupling elements 24, 25 by the first ball device 15 with an angular and/or time offset.

At the end opposite to the bearing device 22, the second ball device 18 has an end stop, which allows for a rotation of less than 360 degrees about the rotational axis 28, and preferably an end stop extension (not shown), which allows for a rotational movement of approximately 660 degrees to 700 degrees about the rotational axis 28.

The valve apparatus 1 is an integral part of the compensating tank apparatus 2.

The first receiving chamber 4 and the second receiving chamber 5 are communicably connected to a first compensating tank 30 and a second compensating tank 31 of the compensating tank apparatus 2 via the first connection port 8 and the second connection port 11.

Outer walls of the compensating tank apparatus 2 that limit the first compensating tank 30 and the second compensating tank 31 are hereinafter referred to as the housing 32.

The integral connection between the valve apparatus 1, in particular the valve housing 3, via the first and second connection ports 8, 11 with the housing 32 of the compensating tank apparatus 2 or the first compensating tank 30 and the second compensating tank 31 is preferably produced by means of an injection molding process. Particularly preferably, the valve housing 3 of the valve apparatus 2 is formed or produced in a single injection molding process with the housing 32 of the compensating tank apparatus 2.

Additionally and/or alternatively, the integral connection can also be produced or replaced by means of a latching connection, a screw connection, an adhesive connection, or a weld connection.

The compensating tank apparatus 2 comprises the first and second compensating tanks 30, 31, both of which are fillable, preferably via a single filling nozzle 33. The compensating tank apparatus 2 also has a bypass line (not shown).

The first and second compensating tanks 30, 31 of the compensating tank apparatus 2 are each equipped with a fluid port 34, 35 for connecting each with a temperature control circuit.

The compensating tank apparatus 2 is a compensating tank apparatus similar to the compensating tank apparatus disclosed in the as yet unpublished European Patent Application EP 2017 4528.8, to which reference is hereby made in full.

Furthermore, according to the present invention, a temperature control circuit apparatus is provided (not shown) comprising the compensating tank apparatus 2 as described above and, accordingly, the valve apparatus 1.

Furthermore, the temperature control circuit apparatus comprises a first temperature control circuit (not shown), wherein the first temperature control circuit is connected to the first and second fluid port 6, 7 of the direct ball valve 16. In addition, a second temperature control circuit (not shown) is provided, which is connected to the third and fourth fluid port 9, 10 of the indirect ball valve 19.

The first temperature control circuit can be configured as a high-temperature control circuit and/or a small circuit having a predetermined total volume, and the second temperature control circuit can be configured as a low-temperature control circuit and/or a large circuit having a predetermined total volume, wherein its total volume is greater than the total volume of the first temperature control circuit. The corresponding arrangement can also be provided inversely, such that the first temperature control circuit is configured as a low-temperature control circuit and/or a large circuit, and the second temperature control circuit is configured as a high-temperature control circuit and/or a small circuit.

Preferably, the compensating tank apparatus 2 according to the invention is provided with a valve apparatus for liquids, in particular for cooling circuits in motor vehicles.

Accordingly, the low-temperature control circuit can be a cooling circuit for an intercooler and/or a battery. The high-temperature control circuit is preferably a cooling circuit for an internal combustion engine.

### LIST OF REFERENCE NUMERALS

1 Valve apparatus
2 Compensating tank apparatus
3 Valve housing
4 First receiving chamber
5 Second receiving chamber
6 First fluid port
7 Second fluid port
8 First connection port
9 Third fluid port
10 Fourth fluid port
11 Second connection port
12 Centering/guiding insert
13 Connector sockets
14 Seal
15 First ball device
16 Direct ball valve
17 First passageway
18 Second ball device
19 Indirect ball valve
20 Second passageway
21 Bearing seat
22 Bearing device
23 Through-opening
24 First coupling element
25 Second coupling element
26 Control shaft
27 Actuator
28 Axis of rotation
29 End stop
30 First compensating tank
31 Second compensating tank
32 Housing
33 Filling nozzle
34 Fluid port
35 Fluid port
36 Sealing wall

1. A valve apparatus for controlling the flow of fluids in two temperature control circuits comprising
an actuator (27),
a valve housing (3) with a first receiving chamber (4) and a second receiving chamber (5),
a direct ball valve (16) having the first receiving chamber (4) with at least a first and a second fluid port (6, 7), wherein in the first receiving chamber (4) a first ball device (15) with a first passageway (17) is rotatably mounted, wherein the first ball device (15) is coupled to the actuator (27) and is directly actuatable by the actuator (27), and
an indirect ball valve (19) having the second receiving chamber (5) with at least a third and a fourth fluid port (9, 10), wherein in the second receiving chamber (5) a second ball device (18) with a second passageway (20) is rotatably mounted, wherein the second ball device (18) is coupled to the first ball device (15) and is thus actuatable by the direct ball valve (16) and indirectly actuatable by the actuator (27).

2. The valve apparatus according to claim 1,
characterized in that
a bearing device (22) for guiding and supporting the first and/or the second ball device (15, 18) in the valve housing (27) is arranged in a coupling region between the first ball device (15) and the second ball device (18) configured as a semi-solid bearing.

3. The valve apparatus according to claim 1,
characterized in that
the ball valves (16, 19) are configured as valves with two or more fluid ports (6, 7, 9, 10, 34, 35), e.g. as 3/2-way valves and/or as proportional valves.

4. The valve apparatus according to claim 1,
characterized in that
the second ball device (18) has an end stop extension that allows a rotational movement of approximately 660° to 700°.

5. The valve apparatus according to claim 1,
characterized in that
the actuator (27) is an electric motor.

6. A compensating tank apparatus (2) with a valve apparatus (1) according to claim 1, wherein the valve apparatus (1) is an integral part of the compensating tank apparatus (2) and a valve housing (3) of the valve apparatus (1) is integrally connected to a housing (33) of the compensating tank apparatus (2).

7. The compensating tank apparatus according to claim 6,
characterized in that
the integral connection between the valve apparatus (1) and the compensating tank apparatus (2) is produced by means of an injection molding process, a latching connection, a screw connection, an adhesive connection, or a weld connection.

8. The compensating tank apparatus according to claim 6,
characterized in that
the compensating tank apparatus (2) comprises a first and a second compensating tank (30, 31), both of which are fillable via a common filling nozzle (33), and/or which have a bypass line, and/or which each have at least one fluid port (34, 35).

9. A temperature control circuit apparatus comprising
a compensating tank apparatus (2) according to claim 6 and
a first temperature control circuit, wherein the first temperature control circuit is connected to a first and a second fluid port (6, 7) of a direct ball valve (16) of a valve apparatus (1), and
a second temperature control circuit, wherein the second temperature control circuit is connected to a third and a fourth fluid port (9, 10) of an indirect ball valve (19) of a valve apparatus (1) or vice versa.

10. The temperature control circuit apparatus according to claim 9,
characterized in that
the first temperature control circuit is configured as a high-temperature control circuit and/or a small circuit having a predetermined total volume, and
wherein the second temperature control circuit is configured as a low temperature control circuit and/or as a large circuit having a predetermined total volume, wherein its total volume is greater than the total volume of the first temperature control circuit.
